(19) United States
(12) Patent Application Publication
(10) Pub. No.: US 2014/0067774 A1
(43) Pub. Date: Mar. 6, 2014

(54) SOCIAL NETWORK RECOMMENDATIONS THROUGH DUPLICATE FILE DETECTION

(71) Applicant: David E. Wilson, Lowell, MA (US)

(72) Inventor: David E. Wilson, Lowell, MA (US)

(73) Assignee: INTERNATIONAL BUSINESS MACHINES CORPORATION, Armonk, NY (US)

(21) Appl. No.: 13/604,129

(22) Filed: Sep. 5, 2012

(51) Int. Cl. G06F 17/30

(52) U.S. Cl. 707/692; 707/E17.005

(57) ABSTRACT

The present disclosure relates generally to the field of social network recommendations through duplicate file detection. In various examples, social network recommendations through duplicate file detection may be implemented in the form of systems, methods and/or algorithms.

### BACKGROUND

The present disclosure relates generally to the field of social network recommendations through duplicate file detection.

In various examples, social network recommendations through duplicate file detection may be implemented in the form of systems, methods and/or algorithms.

Recommendation of people is typically a key component for expanding a social network. In one example, the IBM(R) Connections network from International Business Machines Corporation, Armonk, N.Y., includes Social Analytics widgets which recommend potential colleagues based on “things you have in common”. Algorithms to recommend colleagues are typically based on data accumulated by the social network software.

Another component of the IBM(R) Connections network is a file sharing capability wherein files are uploaded to a central store and shared with colleagues. Individuals can obtain files that they would upload to the file sharing component in various ways. For example, files sent from others via email and documents found on the Internet would be candidates for sharing with others. In an enterprise context, there's a possibility that different individuals would upload the same file and share it with different sets of colleagues.

Algorithms to detect duplicate files are known in the art and products to detect duplicate files on file systems are known in the industry. In this regard, the conventional focus of detecting duplicate files is typically geared toward storage management.

### SUMMARY

In various embodiments, methodologies may be provided that automatically make social network recommendations through duplicate file detection.

In one embodiment, a method implemented in a computer system for providing at least one social network recommendation is provided, the method comprising: receiving, by the computer system, a plurality of files from a respective plurality of users; determining, by the computer system, that at least a first one of the files and a second one of the files are duplicates of each other; and identifying, by the computer system, the user from which the first file had been received and the user from which the second file had been received as recommended social networking partners if it is determined that the first and second files are duplicates of each other.

In another embodiment, a computer readable storage medium, tangibly embodying a program of instructions executable by the computer for providing at least one social network recommendation is provided, the program of instructions, when executing, performing the following steps: receiving, by the computer, a plurality of files from a respective plurality of users; determining, by the computer, that at least a first one of the files and a second one of the files are duplicates of each other; and identifying, by the computer, the user from which the first file had been received and the user from which the second file had been received as recommended social networking partners if it is determined that the first and second files are duplicates of each other.

In another embodiment, a computer-implemented system for providing at least one social network recommendation is provided, the system comprising: an input element configured to receive a plurality of files from a respective plurality of users; a determining element in operative communication with the input element configured to determine that at least a first one of the files and a second one of the files are duplicates of each other; and an identifying element in operative communication with the determining element configured to identify the user from which the first file had been received and the user from which the second file had been received as recommended social networking partners if it is determined that the first and second files are duplicates of each other.

### BRIEF DESCRIPTION OF THE DRAWINGS

Various objects, features and advantages of the present invention will become apparent to one skilled in the art, in view of the following detailed description taken in combination with the attached drawings, in which:

FIG. 1 depicts a flowchart of a method according to an embodiment of the present invention.

FIG. 2 depicts a block diagram of a system according to an embodiment of the present invention.

FIG. 3 depicts a block diagram of a system according to an embodiment of the present invention.

FIG. 4 depicts a block diagram of a system according to an embodiment of the present invention.

### DETAILED DESCRIPTION

In one example, one or more systems may provide for automatically making social network recommendations through duplicate file detection. In another example, one or more methods may provide for automatically making social network recommendations through duplicate file detection. In another example, one or more algorithms may provide for automatically making social network recommendations through duplicate file detection.

As described herein, various mechanisms may provide enhanced potential social networking partner recommendations in a social networking environment. In one example, such a mechanism may comprise: an online social networking system having a plurality of participants interconnected therewith; a duplicate file detection tool (e.g., comprising software or a combination of software and hardware) detecting files that have been uploaded by at least two of the participants; and a social networking recommendation engine (e.g., comprising software or a combination of software and hardware) advising and/or identifying as potential social networking partners those of the participants that have uploaded a duplicate file as detected by the duplicate file detection tool.

In one example, the social networking recommendation engine may provide updates (e.g., scheduled updates) to advise of (and/or identify) changes and/or additions to the potential social networking partners recommendations according to ongoing detection of duplicate file uploads by the duplicate file detection tool.

For the purposes of describing and claiming the present invention the term “duplicate” (as used in the context of duplicate files) is intended to refer to identical. In one example, “duplicate” files may have the same content (and the same formatting of the content). In another example, “duplicate” files may have the same content (but have different formatting of the content and/or different metadata—for example, a POST SCRIPT file and a PDF file may have the same content and different metadata and be considered duplicates).

For the purposes of describing and claiming the present invention the term “social network” is intended to refer to a grouping of people according to one or more relationships between and/or among them. In one example, a social network may include a plurality of members and may be organized and maintained via a computer system.

For the purposes of describing and claiming the present invention the term “social network recommendation” is intended to refer to a recommendation (e.g., made by a computer system) to associate as social networking partners two or more people.

For the purposes of describing and claiming the present invention the term “social networking partners” is intended to refer to two or more people in a social network who are related in some manner. In various examples, such relationships may be as family, as friends, as colleagues, as associates, as “a friend of a friend”, as graduates of the same school and/or any other desired feature or characteristic (e.g., as having uploaded one or more duplicate files).

For the purposes of describing and claiming the present invention the term “recommended social networking partners” is intended to refer to potential social networking partners that are recommended (e.g., via a computer system).

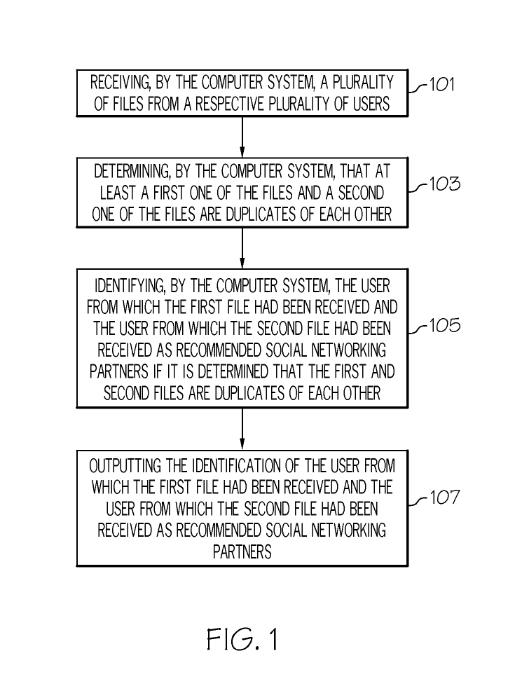

Referring now to FIG. 1, a method implemented in a computer system for providing at least one social network recommendation is shown. As seen in this FIG. 1, the method of this embodiment comprises: at 101—receiving, by the computer system, a plurality of files from a respective plurality of users; at 103—determining, by the computer system, that at least a first one of the files and a second one of the files are duplicates of each other; at 105—identifying, by the computer system, the user from which the first file had been received and the user from which the second file had been received as recommended social networking partners if it is determined that the first and second files are duplicates of each other; and at 107—outputting (by the computer system) the identification of the user from which the first file had been received and the user from which the second file had been received as recommended social networking partners.

In one example, any steps may be carried out in the order recited or the steps may be carried out in another order.

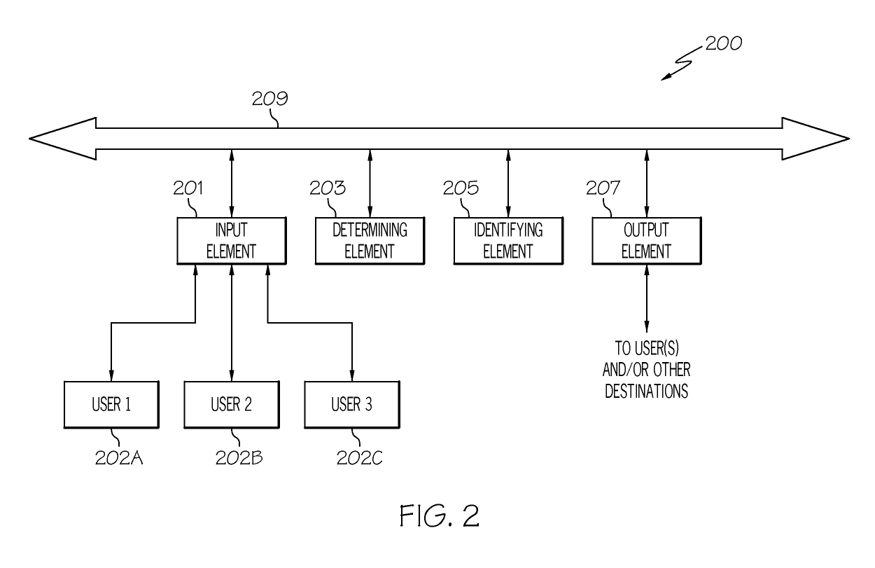

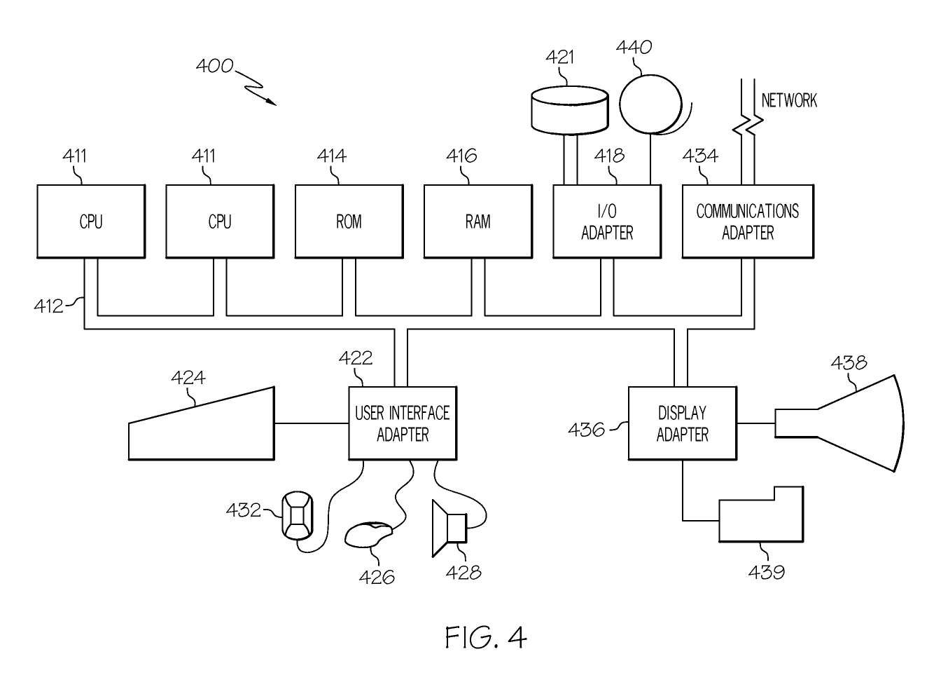

Referring now to FIG. 2, in another embodiment, a system 200 for providing at least one social network recommendation is provided. This system may include the following elements: an input element 201 configured to receive a plurality of files from a respective plurality of users (while three users—user 1 (call out number 202A), user 2 (call out number 202B), and user 3 (call out number 202C)—are shown, any desired number of users may use the system); a determining element 203 in operative communication with the input element configured to determine that at least a first one of the files and a second one of the files are duplicates of each other; an identifying element 205 in operative communication with the determining element configured to identify the user from which the first file had been received and the user from which the second file had been received as recommended social networking partners if it is determined that the first and second files are duplicates of each other; and an output element 207 configured to output the identification of the user from which the first file had been received and the user from which the second file had been received as recommended social networking partners. Each of the input element 201, the determining element 203, the identifying element 205 and the output element 207 may be operatively connected together via system bus 209. In one example, communication between and among the various entities may be bi-directional. In another example, the communication may be carried out via the Internet, an intranet, a local area network, a wide area network and/or any other desired communication channel(s). In another example, some or all of these elements may be implemented in a computer system of the type shown in FIG. 4.

Of note, while FIG. 2 shows various entities communicating, it is to be understood that this FIG. 2 is actually referring to communication by computer system(s) or the like that are owned, leased, operated, used by, in the possession of, and/or controlled by each of the entities.

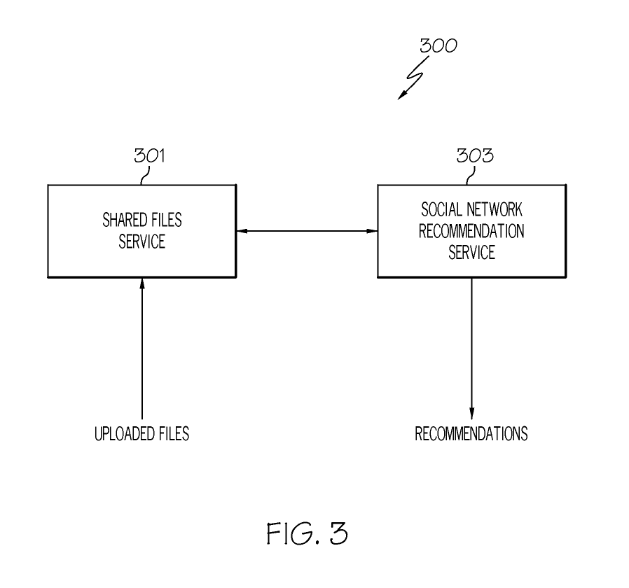

Referring now to FIG. 3, in another embodiment, a system 300 for the detection of duplicate files, e.g., relative to files in a shared files service 301 is provided. Further, the detection results may be input into a social network recommendation service 303. Individuals with whom the duplicate files have been shared may be considered as having “something in common” and may be recommended to each other. In one example, the system 300 may be part of a social networking service. In another example, the communication (e.g., uploading of files to the shared files service 301 and/or the output of recommendation(s)) may be carried out via the Internet, an intranet, a local area network, a wide area network and/or any other desired communication channel(s). In another example, shared files service 301, social network recommendation service 303 and/or system 300 may comprise a software service or a combination of a software/hardware service). In another example, some or all of these elements may be implemented in a computer system of the type shown in FIG. 4.

Referring now to FIG. 4, this figure shows a hardware configuration of computing system 400 according to an embodiment of the present invention. As seen, this hardware configuration has at least one processor or central processing unit (CPU) 411. The CPUs 411 are interconnected via a system bus 412 to a random access memory (RAM) 414, read-only memory (ROM) 416, input/output (I/O) adapter 418 (for connecting peripheral devices such as disk units 421 and tape drives 440 to the bus 412), user interface adapter 422 (for connecting a keyboard 424, mouse 426, speaker 428, microphone 432, and/or other user interface device to the bus 412), a communications adapter 434 for connecting the system 400 to a data processing network, the Internet, an Intranet, a local area network (LAN), etc., and a display adapter 436 for connecting the bus 412 to a display device 438 and/or printer 439 (e.g., a digital printer or the like).

As described herein, in various embodiments additional input is provided into a social network recommendation system of a social network. In one example, if the social network also includes file sharing capability (e.g., allows file uploads), the detection of duplicate or common files shared with disjoint sets of members can be used as such additional input to the social network recommendation system to possibly recommend one or more of these members to each others as potential social networking partners.

In one specific example, as each file is uploaded to a file sharing component of a social network, an algorithm is run to determine if the file is already present in the file sharing service (i.e., is a duplicate). If so, an identification of the members with which the existing file has been shared and those with which the new file has been shared are sent to a social network recommendation engine. The social network recommendation engine can then recommend these individuals (that is, members with which the existing file has been shared and those with which the new file has been shared) as potential social networking partners to each other.

As the files are shared with other members, the social network recommendation engine can be updated with the new potential relationship(s) and can output such updated recommendations.

In various examples, any desired algorithm, known or to be known, for detecting duplicate files may be utilized.

As described herein, various embodiments provide for social networking recommendations based on similarity of shared content in a content sharing system. In one specific example, a mechanism may be provided for determining duplicate content uploaded by two or more individuals and recommending the two or more individuals as social networking partners to each other.

As described herein, in various embodiments a social network recommendation need not be based on examining sets of information that people have authored themselves, or have composed and entered into a system (such as a query) or others have authored about them. Instead, in various embodiments a social network recommendation is based on finding a link between people based on their independently contributing the same piece of information (e.g., a file) to a file sharing service and making a recommendation accordingly. That is, in these embodiments, the content on which the recommendation is made (e.g., the file) has not necessarily been authored by one of the principals in the proposed recommendation (e.g., such as in the case of self-identified profile data) and need not contain any information about the principals in the proposed recommendation (e.g., such as in the case of corporate directory information).

In another example, a “friend of a friend” mechanism may be employed, wherein: (a) a first user from which a first file had been received and a second user from which a second file had been received are recommended social networking partners after it is determined that the first and second files are duplicates of each other; and (b) a third user is recommended as a social networking partner of the first user based upon the third user being a social networking partner of the second user.

In another example, an indicium associated with a user from which a file had been received may comprise the user's name and/or other identifier(s).

In another example, the duplicate files may be selected from the group including (but not limited to): (a) multimedia files; (b) video files; (c) audio files (e.g., music files); (d) image files; (e) text files; (f) word processing files; (g) presentation files; (h) PDF files; (i) database files; (j) spreadsheet files; (k) POST SCRIPT files.

As described herein, in various embodiments people may be recommended to each other based upon receiving and/or posting the same file. That the files were exactly the same (that is, duplicate file detection) could be determined from known algorithms (e.g., using Rabin's algorithm; using various Cryptographic hash functions).

In other embodiments, people may be recommended to each other based upon receiving and/or posting “substantially identical” files. For the purposes of this disclosure, the term “substantially identical” is intended to refer to meeting a relatively high criteria or threshold (e.g., content that is at least 90% identical). Detection of such substantially identical files may be based, for example, on content examination (e.g., using techniques known in the art).

In another example, the content of what is being used as a criteria for making a recommendation may need not be something that the individual authored and may need not be something that the individual had looked for. Rather, in one example, the recommendation may be based on the individual sharing (e.g., posting and/or downloading) some content that has been authored by someone else (and by this act of sharing another user's work, this sharing individual is recommended to another individual who had also shared (e.g., posted and/or downloaded) the work).

In another embodiment a method implemented in a computer system for providing at least one social network recommendation is provided, the method comprising: receiving, by the computer system, a plurality of files from a respective plurality of users; determining, by the computer system, that at least a first one of the files and a second one of the files are duplicates of each other; and identifying, by the computer system, the user from which the first file had been received and the user from which the second file had been received as recommended social networking partners if it is determined that the first and second files are duplicates of each other.

In one example, the method further comprises outputting the identification of the user from which the first file had been received and the user from which the second file had been received as recommended social networking partners.

In another example, the output is provided to at least one of: (a) a computer monitor; and (b) a database.

In another example, the output is provided to each of the user from which the first file had been received and the user from which the second file had been received.

In another example, the output comprises: for the user from which the first file had been received, at least one indicium associated with the user from which the second file had been received; and for the user from which the second file had been received, at least one indicium associated with the user from which the first file had been received.

In another example the plurality of files are received after being uploaded by each of the respective users.

In another example, at least one of: (a) the determining that the first one of the files and the second one of the files are duplicates of each other comprises determining that each of the first one of the files and the second one of the files has the same filename; and (b) the determining that the first one of the files and the second one of the files are duplicates of each other comprises determining that each of the first one of the files and the second one of the files has the same content.

In another example, the determining and identifying are iteratively carried out as the computer system receives additional files.

In another embodiment a computer readable storage medium, tangibly embodying a program of instructions executable by the computer for providing at least one social network recommendation is provided, the program of instructions, when executing, performing the following steps: receiving, by the computer, a plurality of files from a respective plurality of users; determining, by the computer, that at least a first one of the files and a second one of the files are duplicates of each other; and identifying, by the computer, the user from which the first file had been received and the user from which the second file had been received as recommended social networking partners if it is determined that the first and second files are duplicates of each other.

In one example, the program of instructions, when executing, further outputs the identification of the user from which the first file had been received and the user from which the second file had been received as recommended social networking partners.

In another example, the output is provided to at least one of: (a) a computer monitor; and (b) a database.

In another example, the output is provided to each of the user from which the first file had been received and the user from which the second file had been received.

In another example, the output comprises: for the user from which the first file had been received, at least one indicium associated with the user from which the second file had been received; and for the user from which the second file had been received, at least one indicium associated with the user from which the first file had been received.

In another example the plurality of files are received after being uploaded by each of the respective users.

In another example, at least one of: (a) the determining that the first one of the files and the second one of the files are duplicates of each other comprises determining that each of the first one of the files and the second one of the files has the same filename; and (b) the determining that the first one of the files and the second one of the files are duplicates of each other comprises determining that each of the first one of the files and the second one of the files has the same content.

In another example, the determining and identifying are iteratively carried out as additional files are received.

In another embodiment a computer-implemented system for providing at least one social network recommendation is provided, the system comprising: an input element configured to receive a plurality of files from a respective plurality of users; a determining element in operative communication with the input element configured to determine that at least a first one of the files and a second one of the files are duplicates of each other; and an identifying element in operative communication with the determining element configured to identify the user from which the first file had been received and the user from which the second file had been received as recommended social networking partners if it is determined that the first and second files are duplicates of each other.

In another example, the system further comprises an output element configured to output the identification of the user from which the first file had been received and the user from which the second file had been received as recommended social networking partners.

In another example, the output is provided to at least one of: (a) a computer monitor; and (b) a database.

In another example, the output is provided to each of the user from which the first file had been received and the user from which the second file had been received.

In another example, the output comprises: for the user from which the first file had been received, at least one indicium associated with the user from which the second file had been received; and for the user from which the second file had been received, at least one indicium associated with the user from which the first file had been received.

In another example, the plurality of files are received after being uploaded by each of the respective users.

In another example, at least one of: (a) the determining element is configured to determine that the first one of the files and the second one of the files are duplicates of each other by determining that each of the first one of the files and the second one of the files has the same filename; and (b) the determining element is configured to determine that the first one of the files and the second one of the files are duplicates of each other by determining that each of the first one of the files and the second one of the files has the same content.

In another example, the determining and identifying are iteratively carried out as the input element receives additional files.

In other examples, any steps described herein may be carried out in any appropriate desired order.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any programming language or any combination of one or more programming languages, including an object oriented programming language such as Java, Smalltalk, C++ or the like or a procedural programming language, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention may be described herein with reference to flowchart illustrations and/or block diagrams of methods, systems and/or computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus or other devices provide processes for implementing the functions/acts specified in the flowchart and/or block diagram block or blocks.

The flowcharts and block diagrams in the figures illustrate the architecture, functionality, and operation of possible implementations of systems, methods and computer program products according to various embodiments of the present invention. In this regard, each block in the flowcharts or block diagrams may represent a module, segment, or portion of code, which comprises one or more executable instructions for implementing the specified logical function(s). It should also be noted that, in some implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

It is noted that the foregoing has outlined some of the objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the features and applications of the invention. Other beneficial results can be realized by applying the disclosed invention in a different manner or modifying the invention in ways known to those familiar with the art. In addition, all of the examples disclosed herein are intended to be illustrative, and not restrictive.

What is claimed is:

1. A method implemented in a computer system for providing at least one social network recommendation, the method comprising:
receiving, by the computer system, a plurality of files from a respective plurality of users;
determining, by the computer system, that at least a first one of the files and a second one of the files are duplicates of each other; and
identifying, by the computer system, the user from which the first file had been received and the user from which the second file had been received as recommended social networking partners if it is determined that the first and second files are duplicates of each other.

2. The method of claim 1, further comprising outputting the identification of the user from which the first file had been received and the user from which the second file had been received as recommended social networking partners.

3. The method of claim 1, wherein the output is provided to at least one of: (a) a computer monitor; and (b) a database.

4. The method of claim 1, wherein the output is provided to each of the user from which the first file had been received and the user from which the second file had been received.

5. The method of claim 1, wherein the output comprises:
for the user from which the first file had been received, at least one indicium associated with the user from which the second file had been received; and
for the user from which the second file had been received, at least one indicium associated with the user from which the first file had been received.

6. The method of claim 1, wherein the plurality of files are received after being uploaded by each of the respective users.

7. The method of claim 1, wherein at least one of:
(a) the determining that the first one of the files and the second one of the files are duplicates of each other comprises determining that each of the first one of the files and the second one of the files has the same filename; and
(b) the determining that the first one of the files and the second one of the files are duplicates of each other comprises determining that each of the first one of the files and the second one of the files has the same content.

8. The method of claim 1, wherein the determining and identifying are iteratively carried out as the computer system receives additional files.

9. A computer readable storage medium, tangibly embodying a program of instructions executable by the computer for providing at least one social network recommendation, the program of instructions, when executing, performing the following steps:
receiving, by the computer, a plurality of files from a respective plurality of users;
determining, by the computer, that at least a first one of the files and a second one of the files are duplicates of each other; and
identifying, by the computer, the user from which the first file had been received and the user from which the second file had been received as recommended social networking partners if it is determined that the first and second files are duplicates of each other.

10. The computer readable storage medium of claim 9, wherein the program of instructions, when executing, further outputs the identification of the user from which the first file had been received and the user from which the second file had been received as recommended social networking partners.

11. The computer readable storage medium of claim 9, wherein the output is provided to at least one of: (a) a computer monitor; and (b) a database.

12. The computer readable storage medium of claim 9, wherein the output is provided to each of the user from which the first file had been received and the user from which the second file had been received.

13. The computer readable storage medium of claim 9, wherein the output comprises:
for the user from which the first file had been received, at least one indicium associated with the user from which the second file had been received; and
for the user from which the second file had been received, at least one indicium associated with the user from which the first file had been received.

14. The computer readable storage medium of claim 9, wherein the plurality of files are received after being uploaded by each of the respective users.

15. The computer readable storage medium of claim 9, wherein at least one of:
(a) the determining that the first one of the files and the second one of the files are duplicates of each other comprises determining that each of the first one of the files and the second one of the files has the same filename; and
(b) the determining that the first one of the files and the second one of the files are duplicates of each other comprises determining that each of the first one of the files and the second one of the files has the same content.

16. The computer readable storage medium of claim 9, wherein the determining and identifying are iteratively carried out as additional files are received.

17. A computer-implemented system for providing at least one social network recommendation, the system comprising:
an input element configured to receive a plurality of files from a respective plurality of users;
a determining element in operative communication with the input element configured to determine that at least a first one of the files and a second one of the files are duplicates of each other; and
an identifying element in operative communication with the determining element configured to identify the user from which the first file had been received and the user from which the second file had been received as recommended social networking partners if it is determined that the first and second files are duplicates of each other.

18. The system of claim 17, further comprising an output element configured to output the identification of the user from which the first file had been received and the user from which the second file had been received as recommended social networking partners.

19. The system of claim 17, wherein the output is provided to at least one of: (a) a computer monitor; and (b) a database.

20. The system of claim 17, wherein the output is provided to each of the user from which the first file had been received and the user from which the second file had been received.
